(19) United States
(12) Patent Application Publication
(10) Pub. No.: US 2009/0321997 A1
(43) Pub. Date: Dec. 31, 2009

(54) PROCESS FOR CONTROLLING THE MANUFACTURE OF ELECTROSPUN FIBER MORPHOLOGY

(75) Inventors: Darrell RENEKER, Akron, OH (US); Sureeporn TRIPATANASUWAN, Bangkok (TH)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/042,809

(22) Filed: Mar. 5, 2008

Related U.S. Application Data
(60) Provisional application No. 60/904,984, filed on Mar. 5, 2007.

(51) Int. Cl. D01D 5/096; B29C 47/92

(52) U.S. Cl. 264/465; 425/76

(57) ABSTRACT

A apparatus and process of forming electrospun fibers including the steps of supplying a substantially homogeneous mixture of a solvent and a polymer which can be formed into an electrospun fiber; electrospinning the polymer into a fiber in an enclosed chamber; monitoring the humidity in said chamber; and changing the partial pressure of solvent evaporation to thereby modify the morphology of the thus formed fibers.

### BACKGROUND OF THE INVENTION

This invention is related to a process for making electrospun fibers by controlling the vapor pressure of the process.

The electrospinning process uses electrical force to produce nanofibers. A charged droplet acquires a conical shape known as a Taylor cone and then becomes unstable. A charged jet ejects from a vertex and developes a spiral path due to the electrically driven bending instability, making it possible for the jet to elongate by a large amount and produce nanofibers in a small space.

Electrospinning is receiving attention due to its cost effectiveness and the straightforward route to nanofibers. Electrospun fibers and electrospinning processes have many potential applications including filtration, biomedical application, fuel cells, solar sails and composites. Many polymer and ceramic precursor nanofibers have been successfully electrospun with diameters in the range from 1 nm to several microns.

The process of electrospinning generally involves the creation of an electrical field at the surface of a liquid. The resulting electrical forces create a jet of liquid which carries an electrical charge. Thus, the liquid jets may be attracted to other electrically charged objects at a suitable electrical potential. As the jet of liquid elongates and travels, it hardens and dries. The hardening and drying of the elongated jet of liquid may be caused by cooling of the liquid, i.e., where the liquid is normally a solid at room temperature; evaporation of a solvent, for example, by dehydration, (physically induced hardening); or by a curing mechanism (chemically induced hardening). The produced fibers are collected on a suitably located, oppositely charged receiver and subsequently removed from the receiver as needed, or directly applied to an oppositely charged generalized target area.

The electric force causes the jet to emerge from a Taylor cone. The charged jet of polymer solution elongates and moves toward the collector in a straight line for a distance, and then begins to bend and develop a spiral path. The repulsive force between charges carried by the jet causes the jet to elongate and thin. The elongation and thinning of the charged jet continue until solidification occurs. Many factors affect the fiber diameter and morphology. Both intrinsic solution properties, including viscosity, concentration, surface tension, relaxation time, and processing parameters, including applied potential, distance from polymer droplet to grounded collector, size of orifice and temperature affect the fiber diameter and morphology.

Many attempts have been made to control the diameter of the nanofibers. Fridrikh et al. did not mention the partial pressure of the solvent as a control parameter. Lee et al., in their conclusions, suggested that “there was an optimum electric current value for obtaining uniform high quality nanofibers when . . . ” salt was added to the solution. Tan et al. reported on the effects of polymer concentration in the solution, molecular weight of the polymer, electrical conductivity of the solvent, the electrical voltage used, and the feed rate of the fluid to the process. They concluded the polymer concentration, the molecular weight, and the electrical conductivity were the dominant parameters, but made no mention of the ambient atmosphere.

Yarin proposed a mathematical model to calculate jet path and fiber diameter during the electrospinning process. The mathematical model being based on the balance of forces acting on the charged jet, including the Coulombic force between charges carried with the jet, force from the electric field, surface tension force, and viscoelastic force. Two publications regarding mathematical models were reported, the first without evaporation and solidification, and the second including evaporation and solidification. Results from the mathematical model without evaporation showed the charged jet continues to elongate indefinitely. When the effect of evaporation and solidification were accounted for in the calculation, a quantitative agreement between experiment and calculation was formed. Evaporation of the solvent changes the viscoelastic properties of the polymer solutions, gradually making it harder for the charged jet to elongate.

### SUMMARY OF THE INVENTION

The present invention is to a process and apparatus for making electrospun fibers by controlling the vapor pressure of the process. The process of forming electrospun fibers including the steps of supplying a substantially homogeneous mixture of a solvent and a polymer which can be formed into an electrospun fiber; electrospinning the polymer into a fiber in an enclosed chamber; monitoring the humidity in said chamber; and changing the partial pressure of solvent evaporation to thereby modify the morphology of the thus formed fibers. The fibers can be produced with controlled diameters, and can result in fibers having smaller diameters than are normally achieved in an electrospinning process. The present process can control the balance between the formations of beads, branches, ribbons, and surface skins that may lead to ribbons and garlands.

### BRIEF DESCRIPTION OF THE DRAWINGS

The features and advantages of the present invention will become more apparent from the detailed description set forth below when taken in conjunction with the drawings.

FIG. 1 is a perspective view of an apparatus for use in the present process;

FIG. 2 details scanning electron micrographs of the poly(ethylene oxide) nanofibers elecrospun in air at 5.1% to 63.5% relative humidity;

FIG. 3 is a graph detailing the average fiber diameter as a function of relative humidity;

FIG. 4 is a graph detailing the average bead diameter, bead length and distance between beads at different relative humidity; and

FIG. 5 is an optical micrograph of poly(ethylene oxide) electrospun from aqueous solution under (a) 8.8%, (b) 20.7%, (c) 40.8%, and (d) 57.3% relative humidity.

### DETAILED DESCRIPTION OF THE INVENTION

The present process involves the control of the evaporation of the solvent used to make the fibers, and in turn the associated solidification and formation of the fibers. These factors also determine the diameter of the electrospun nanofibers. The elongation and thinning of a charged jet stops when the charged jet is solidified. The evaporation and solidification of the charged jet are controlled by varying the partial pressure of the solvent during electrospinning.

The invention will be explained in the context of a water borne polymer, where the partial pressure of the water vapor of poly(ethylene oxide) from aqueous solution is controlled. As the partial pressure of water vapor increases, the solidification process of the charged jet becomes slower, allowing elongation of the charged jet to continue and thereby form thinner fibers.

The present process is not limited to aqueous solvent products. The process applies to most polymers electrospun from solution. In the process example, the rate of solvent evaporation and the solidification of a charged jet were controlled during electrospinning of poly(ethylene oxide) in aqueous solution. The evaporation rate of the solvent, in this case water, was controlled by changing the partial pressure of water vapor in the air surrounding the jet. The decreased evaporation rate of solvent from the jet allows the charged jet to remain fluid, continue to elongate, and become thinner.

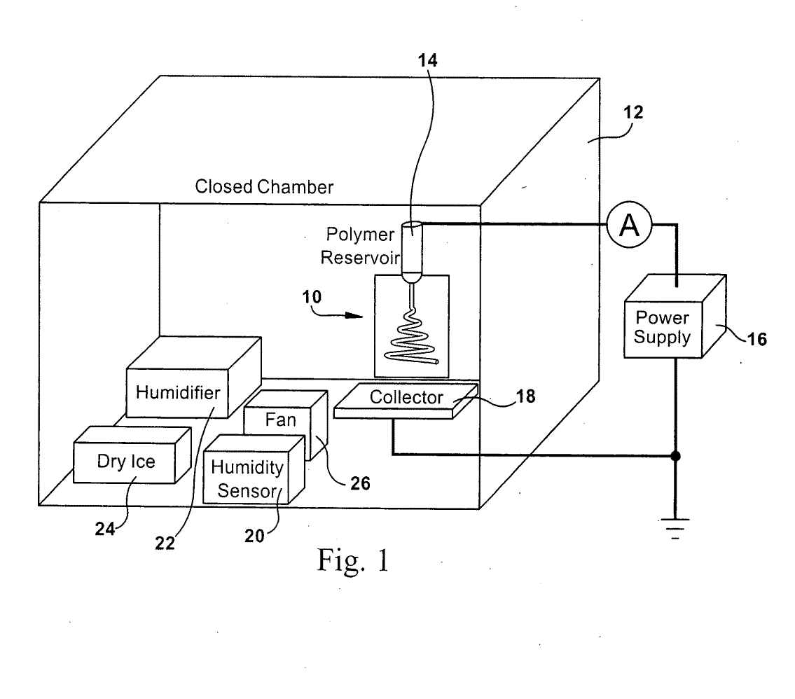

The apparatus for practicing the process of the present invention is shown in FIG. 1. The basic electrospinning apparatus is known and is disclosed in U.S. Pat. Nos. 6,110,590 and 6,753,454, the disclosures of which are incorporated herein by reference.

The apparatus consists of an electrospinning apparatus 10 in an enclosed chamber 12, which allows the humidity of the chamber to be measured and controlled. The electrospinning apparatus 10 consists of a polymer reservoir 14 which supplies a uniform mixture of solvent and fiber forming polymer to the electrospinning apparatus. The fiber is drawn from the outlet from the polymer supply reservoir 14 by the electrical force created by the electrical potential supplied by power supply 16 which creates a differential between reservoir 14 and a fiber collector 18. As noted earlier, the electrospinning apparatus is known in the art.

The enclosed chamber 12 allows for the control of the vapor pressure of the solvent employed in the process and thus the morphology of the fibers that are formed. The enclosed chamber employs a humidity sensor 20, such as a hygrometer, to provide a measurement of the humidity. A humidifying device 22, such as a wick or ultrasonic humidifier, is employed to increase the humidity in the chamber, while a cooling device 24 is employed to lower the humidity. A fan 26 is employed to circulate the air in the chamber and provide uniform distribution of the humidity. In the case of other electrospinning processes, where the solvent may be an organic solvent or alcohol, the vapor pressure may be controlled by injecting the solvent into the chamber to increase the vapor pressure and by selective absorption of the solvent vapor to reduce the vapor pressure. Furthermore, the ambient gas in the chamber can be air or any inert gas such as nitrogen or argon. The possibility that the concentration of an organic solvent, required for control, in air can raise issues of working with an explosive mixture, and for safety reasons should always be avoided. Alternative non-flammable solvents may be available, and in cases were a flammable solvent is essential, the ambient air can be replaced with an inert gas.

### Experimental

Poly(ethylene oxide) with molecular weight of 400,000 g/mol obtained from Scientific Polymer was used. The aqueous solution of poly(ethylene oxide) was prepared at room temperature at concentration of 6% by weight. The solution was electrospun in a closed chamber in which the relative humidity during the electrospinning process was controlled. FIG. 1 shows the arrangement used in this study. An ultrasonic humidifier and dry ice, as the cooling device, were used to increase or decrease humidity in the chamber. Circulation of water vapor was maintained by a fan. Poly(ethylene oxide) aqueous solution was held in a glass pipette, that was connected to a high voltage power supply. A flat metal collector was placed 18 cm below tip of the glass pipette. The applied potential difference between the top and the collector was 5 kV. Current, temperature and humidity of the air in the chamber were monitored during the electrospinning process. The humidity and temperature sensor used in this experiment was HTM 1505 (±0.2% RH, ±0.5° C.) manufactured by Humerel.

Morphological features of the electrospun fibers were observed with a scanning electron microscope, a JEOL model JSM-7401F and with an Olympus model DP70 optical microscope.

The average fiber diameter, bead diameter, bead length, distance between beads were obtained by using image analysis software version 3.0.1.0, available from Digimizer. The measurement was done at every 2 micron length of 10 segments. The total number of data points for each sample was about 50.

TABLE 1
Relative humidity, temperature, and the average fiber diameters

| Relative humidity | Temperature | Average fiber diameter |
|---|---|---|
| (%) | (° C.) | (nm) |
| 5.1 | 21.0 | 253 ± 24 |
| 8.8 | 21.0 | 249 ± 26 |
| 20.7 | 21.4 | 223 ± 24 |
| 30.6 | 21.6 | 231 ± 23 |
| 40.8 | 22.0 | 160 ± 15 |
| 48.7 | 22.2 | 144 ± 16 |
| 52.6 | 22.4 | 132 ± 23 |
| 57.3 | 23.2 | 103 ± 27 |
| 58.9 | 23.2 | 80 ± 17 |
| 61.2 | 23.2 | 77 ± 17 |
| 63.5 | 23.2 | 63 ± 16 |

Note:
Humidity inside chamber at each data point was kept at ±0.4% RH. The observed current flowing from the tip was constant around 400 nA.

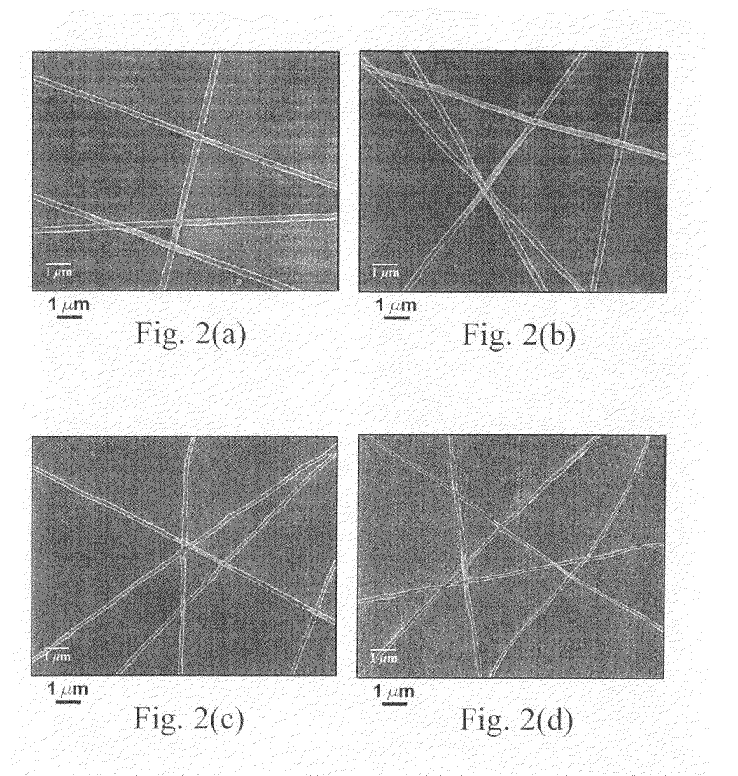

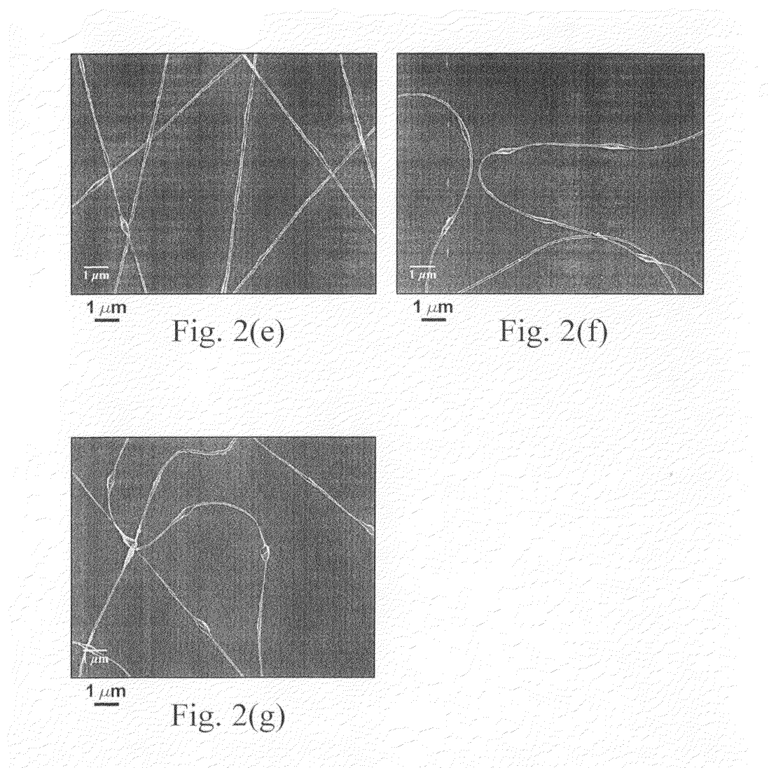

FIG. 2(a)-(g) shows scanning electron micrographs of poly(ethylene oxide) nanofibers elecrospun in air from an aqueous solution at (a) 8.8%, (b) 20.7%, (c) 40.8%, (d) 52.6%, (e) 57.3%, (f) 61.2% and (g) 63.5% relative humidity. The 5.1% to 63.5% range of relative humidity, as reported in Table 1, resulted in the average diameter of poly(ethylene oxide) nanofibers gradually decreasing from around 253 nm when electrospun at 5.1% relative humidity to around 63 nm when electrospun at 63% relative humidity.

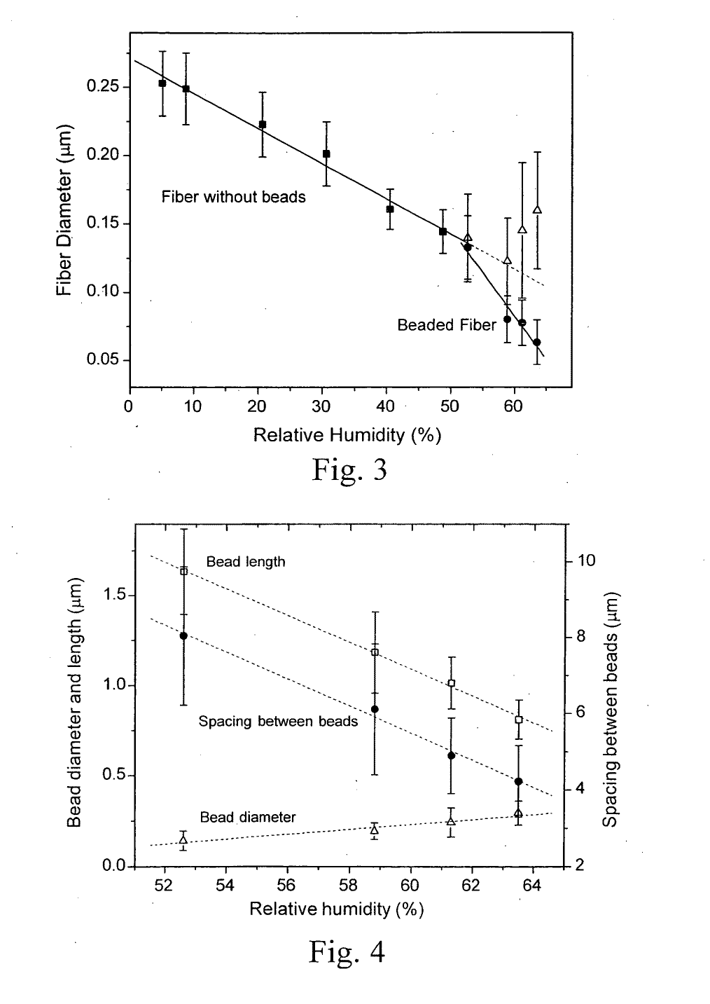

FIG. 3 shows the average fiber diameter as a function of relative humidity. The charged jet solidified at the largest diameter when electrospun at low humidity since water in the jet evaporated rapidly. When the charged jet becomes very thin, the charges carried by the jet move further apart. The surface area increases, and the charge per unit area on the surface of the jet decreases. The development of the capillary instability creates thin fiber segments between beads with diameter larger than the fiber. Beaded fibers appeared at 51% relative humidity and higher. The capillary instability of a fluid jet, which causes a cylindrical jet to break up into droplets, is a well known phenomenon. The surface energy of fluid in the form of a jet is higher than that of same volume of liquid in the form of drops. Several factors are known to affect the formation of beaded fibers. The volume of the beads relative to the volume of the fibers increased when electrospun under higher relative humidity. When the fibers were thinner, the bead diameter increased, the length of the beads decreased and the spacing between beads becomes smaller as shown in FIG. 3 and FIG. 4, which shows the average bead diameter, bead length and distance between beads at different relative humidity.

The solid line in FIG. 3 shows the average fiber diameters at different relative humidity and it the linear fit of the average fiber diameter, ignoring the beads. The average fiber diameter decreased sharply when beads started to occur at 52.6% relative humidity. The total volume of polymer per unit length of the beaded fibers was calculated by adding the volume of the beads and the volume of the fibers, based on measurements of the images. The diameter corresponding to the volume per unit length is plotted as triangles in FIG. 3. The apparent increase in the observed mass per unit length suggests that the beads growth shortens the length of the fiber segments between the beads.

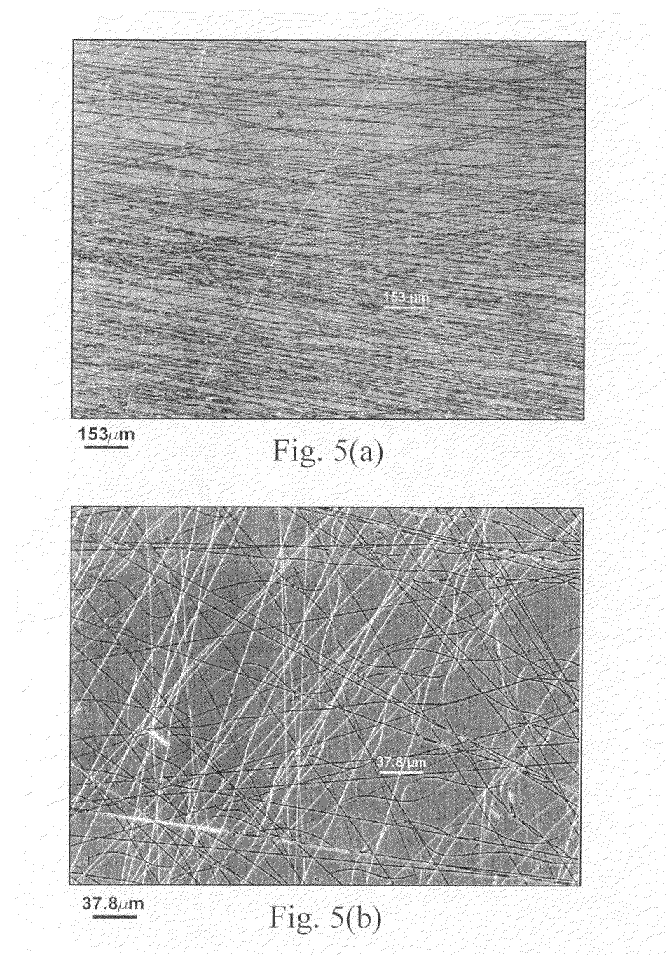

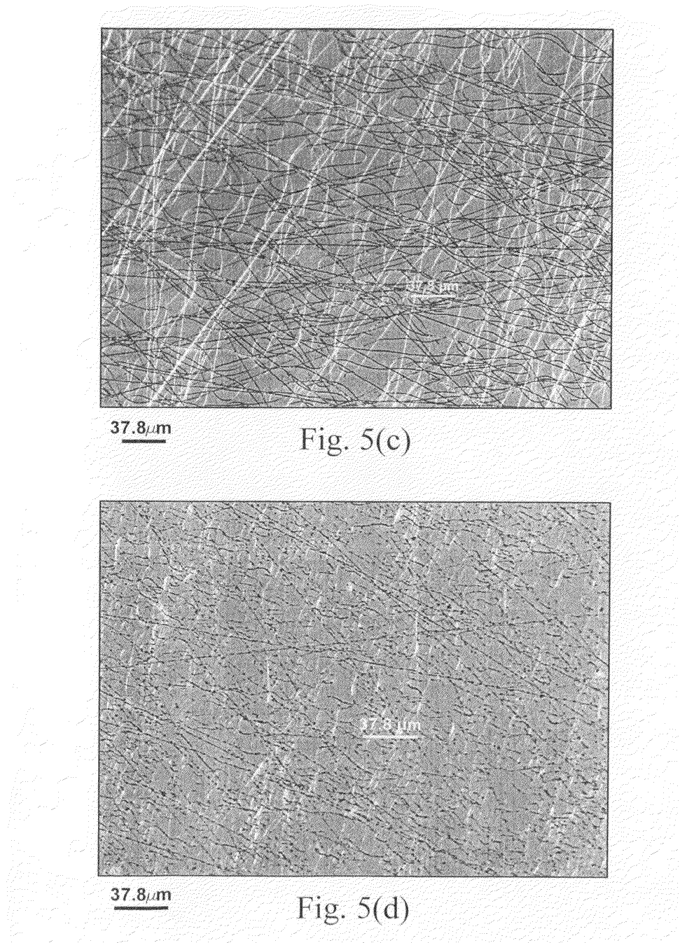

The fibers were collected after the first electrical bending instability coils had grown to a diameter of about 100 mm. As seen in FIG. 5, the optical micrograph of poly(ethylene oxide) electrospun from aqueous solution under (a) 8.8%, (b) 20.7%, (c) 40.8%, and (d) 57.3% relative humidity shows the fibers collected. No second or higher bending coils were seen when electrospun at low humidity as shown in FIG. 5a. The more flexible jets electrospun at higher humidity developed higher orders of bending coils with diameters ranging from 100 mm to 0.05 mm. At the higher value of relative humidity, beads developed on the most segments of the fibers.

By controlling the evaporation and solidification affects, the fiber diameter of the fibers produced by the process can be controlled as well. By slowing evaporation and solidification, smaller fiber diameter fibers can be produced. Also, beaded fibers can be produced when the jet diameter is very thin and the charge per unit area is smaller. As such, the fibers produced by such a process can be thinner than those made by a traditional electrospinning process. The resulting fiber products will be more flexible and have a larger surface area per unit mass.

Electrospinning is widely used to make nanofibers for filtration. Other uses, for example, in biomedical applications are developing rapidly. During electrospinning an electrically charged jet is elongated by the repulsive force between electrical charges carried with the jet. The charged jet develops a spiral path known in the art, which makes it possible for the jet to elongate and produce nanofibers in a small space. Where the fibers are soluble, they can be used in products where the fibers are solubilized since the thinner fibers will dissolve faster. Still further, the thinning process results in orientation or alignment of the molecules in the regions that are thinned and provide beneficial tensile properties and/optical properties.

The process is also useful in making fibers having various shapes, including beads of various shapes, branches, and garlands. Such shapes have known utilities and could be used in filtration and catalysis applications.

### THE FOLLOWING REFERENCES ARE HEREIN INCORPORATED BY REFERENCE

1. Yarin, A. L.; Koombhongse, S., Reneker, D. H., J. Appl. Phys., 2001, 90, 4836.

2. Reneker, D. H.; Yarin, A. L.; Fong, H.; Koombhongse, S., J. Appl. Phys., 2000, 87, 4531.

3. Yarin, A. L.; Koombhongse, S., Reneker, D. H., J. Appl. Phys., 2001, 90, 4863.

4. Hajra, M. G.; Mehta, K.; Chase, G. G., Separation Purification Technol., 2003, 30, 79.

5. Min, B.-M.; Lee, G.; Kim, S. H.; Nam, Y. S.; Lee, T. S.b; Park, W. H., Biomaterials, 2004, 25, 1289

6. Azad, A.-M.; Matthews, T.; Swary, J., Mater. Sci. Eng. B, 2005, 123, 252.

7. White, K.; Lennhoff, J.; Sally, E.; Jayne, K., Proceedings of The Fiber Society Annual Fall Technical Meeting; Natick, Mass., October, 2002.

8. Wang, M.; Singh, H.; Hatton, T. A.; Rutledge, G. C., Polymer, 2004, 45, 5505. Fridrikh, S. V.; Yu, J. H.; Brenner, M. P; Rutledge, G. C., Phys. Rev. Lett., 2003, 90(14), 144502.

9. Lee, C. K.; Kim, S. I.; Kim, S. J., Synthetic Metals, 2005, 154, 209.

10. Tan, S. H.; Inai, R.; Kotaki, M.; Ramakrishna, S., Polymer, 2005, 46, 6128.

11. Fong, H; Chun, I; Reneker, D. H., Polymer, 1999, 40, 4585.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What we claim is:

1. A process of forming electrospun fibers comprising the steps of
supplying a substantially homogeneous mixture of a solvent and a polymer which can be formed into an electrospun fiber;
electrospinning said polymer into a fiber in an enclosed chamber;
monitoring the humidity in said chamber; and
changing the partial pressure of solvent evaporation to thereby modify the morphology of the thus formed fibers.

2. The process of claim 1 wherein the polymer is poly(ethylene oxide).

3. The process of claim 1 wherein the solvent is water.

4. The process of claim 1 wherein the control of the partial pressure of the solvent controls the diameter of the fibers and/or the formation of beads, branches, ribbons, and surface skins on the fibers.

5. An apparatus for electrospinning at least one polymer fiber comprising:
at least one reservoir for holding a uniform mixture of solvent and fiber forming polymer;
at least one device for electrospinning at least one fiber, the at least one device being in fluid communication with the at least one reservoir;
a mixing device for agitating the fluid within the reservoir;
a power source capable of generating an electric field in electrical communication with the at least one device;
a device for focusing the electrospun fibers into a defined area;
an enclosed chamber for enclosing said electrospinning apparatus;
means for measuring the humidity within the enclosure;
means for changing the partial pressure of the solvent evaporation to thereby change the morphology of the thus formed fibers; and
means for collecting said fibers.

6. The apparatus of claim 5 wherein the polymer is poly(ethylene oxide).

7. The apparatus of claim 5 wherein the solvent is water.

8. The apparatus of claim 5 wherein the control of the partial pressure of the solvent controls the diameter of the fibers and/or the formation of beads, branches, ribbons, and surface skins on the fibers.

9. The apparatus of claim 5 wherein the control of the partial pressure of the solvent controls the diameter of the fibers.
